(19) United States
(12) Patent Application Publication
(10) Pub. No.: US 2024/0232577 A1
(43) Pub. Date: Jul. 11, 2024

(54) TRAINED MODEL GENERATION METHOD, PROGRAM, STORAGE MEDIUM, AND TRAINED MODEL

(71) Applicant: DAIKIN INDUSTRIES, LTD., Osaka (JP)

(72) Inventors: Ryoya HOGAKI, Osaka (JP); Seigo MIZUTANI, Osaka (JP); Takuma IWASAKA, Osaka (JP); Nozomi YAMAGUCHI, Osaka (JP); Takuya YOSHIOKA, Osaka (JP); Katsuhiko IMOTO, Osaka (JP)

(73) Assignee: DAIKIN INDUSTRIES, LTD., Osaka (JP)

(21) Appl. No.: 18/430,295

(22) Filed: Feb. 1, 2024

Related U.S. Application Data
(63) Continuation of application No. PCT/JP2022/028696, filed on Jul. 26, 2022.

(30) Foreign Application Priority Data
Aug. 2, 2021 (JP) 2021-126492

(51) Int. Cl. G06N 3/042

(52) U.S. Cl. CPC G06N 3/042

(57) ABSTRACT

A trained model generation method relating to coating material. A trained model generation method for generating a trained model that determines, using a computer, evaluation of an article including coating material on a substrate, including: an acquisition step (S12) of causing the computer to acquire training data information including coating material information and the evaluation of the article, the coating material information corresponding to information of the coating material; a training step (S15) of training the computer based on a plurality of the training data from the acquisition step; and a generation step (S16) of causing the computer to generate the trained model based on training results in the training step. The trained model is configured to receive input information and to yield the evaluation, the input information corresponding to unknown information different from the training data. The input information corresponds to information including at least the coating material information.

### CROSS REFERENCE TO RELATED APPLICATION

This application is a Rule 53(b) Continuation of International Application No. PCT/JP2022/028696 filed Jul. 26, 2022, claiming priority based on Japanese Application No. 2021-126492 filed on Aug. 2, 2021, the respective disclosures of which are incorporated herein by reference in their entirety.

### TECHNICAL FIELD

The disclosure relates to trained model generation methods, programs, storage media storing programs, and trained models.

### BACKGROUND ART

Patent Literature 1 discloses a trained model generation method of generating a trained model for determining, using a computer, evaluation of an article in which a surface-treating agent is fixed onto a base material, a program, a storage medium storing the program, and a trained model.

### CITATION LIST

### Patent Literature

Patent Literature 1: WO 2020/230781

### SUMMARY

The disclosure also relates to a trained model generation method for generating a trained model that determines, using a computer, evaluation of an article including a coating material fixed on a substrate, the method including:
an acquisition step (S12) of causing the computer to acquire, as training data, information including at least coating material information and the evaluation of the article, the coating material information corresponding to information of the coating material;
a training step (S15) of training the computer based on a plurality of the training data acquired in the acquisition step (S12); and
a generation step (S16) of causing the computer to generate the trained model based on training results in the training step (S15),
the trained model being configured to receive input information corresponding to unknown information different from the training data and to yield the evaluation,
the input information corresponding to information including at least the coating material information.

### Advantageous Effects

The disclosure can provide a novel trained model generation method relating to a coating material, a program, a storage medium storing the program, and a trained model.

### BRIEF DESCRIPTION OF THE DRAWINGS

FIG. 1 is a diagram of a structure of a trained model generation device.

FIG. 2 is a diagram of a structure of a user device.

FIG. 3 is an example of a decision tree.

FIG. 4 is an example of a feature space split by a decision tree.

FIG. 5 is an example of a SVM.

FIG. 6 is an example of a feature space.

FIG. 7 is an example of a neuron model in a neural network.

FIG. 8 is an example of a neural network.

FIG. 9 is an example of training data.

FIG. 10 is a flowchart of operations of a trained model generation device.

FIG. 11 is a flowchart of operations of a user device.

### DESCRIPTION OF EMBODIMENTS

The following describes a trained model according to an embodiment of the disclosure. The following embodiment is a specific example and does not limit the technical scope and may be modified as appropriate without departing from the spirit of the disclosure.

### (1) Outline

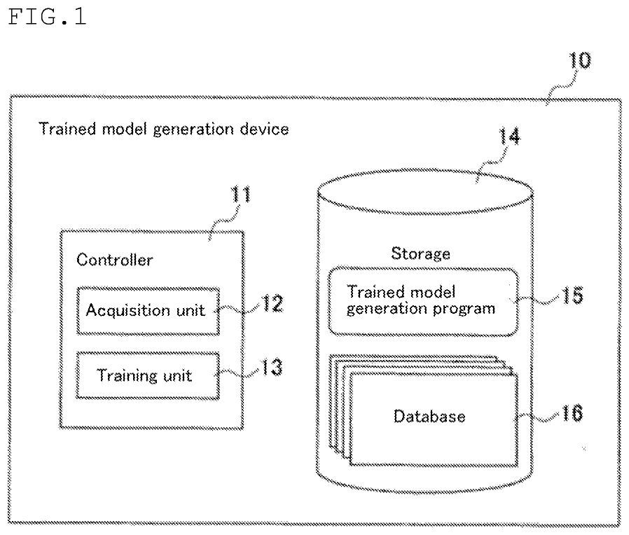

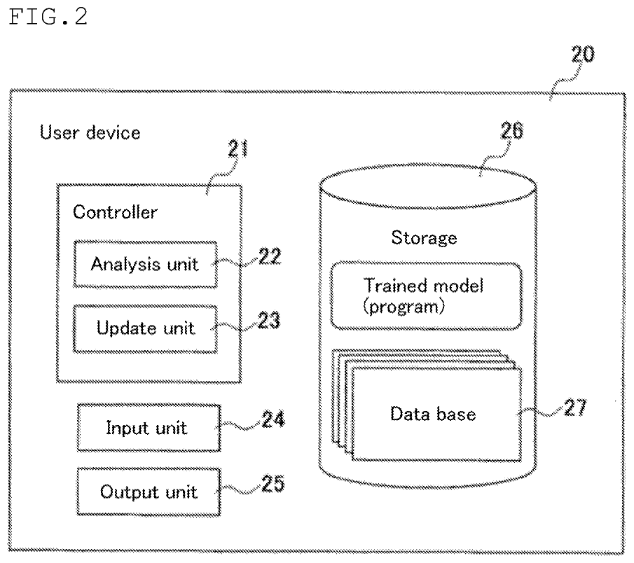

FIG. 1 is a diagram of a structure of a trained model generation device. FIG. 2 is a diagram of a structure of a user device.

A trained model is generated by causing a trained model generation device 10, which is composed of one or more computers, to acquire and learn training data. The resulting trained model, as what is called a learned model, is implemented to a general-purpose computer or terminal, or downloaded as a program, or distributed while being stored in a storage medium, and is then used in a user device 20, which is composed of one or more computers.

The trained model can yield a correct answer to unknown information different from the training data. The trained model can be updated so as to yield a correct answer to a variety of data entered.

### (2) Structure of Trained Model Generation Device 10

The trained model generation device 10 generates a trained model to be used in a user device 20, which will be described later.

The trained model generation device 10 is a device having functions of what is called a computer. The trained model generation device 10 may include a communication interface such as a NIC and a DMA controller, and may be communicable with, for example, a user device 20 via a network. The trained model generation device 10 shown in FIG. 1 is illustrated as a single device, but is preferably compatible with cloud computing. Thus, the hardware structure of the trained model generation device 10 is not necessarily accommodated in a single housing or provided as a single device. For example, the trained model generation device 10 may be structured such that the hardware resources thereof are dynamically connected and disconnected in response to a load.

The trained model generation device 10 includes a controller 11 and a storage 14.

### (2-1) Controller 11

The controller 11 may be a CPU, for example, and controls the entire trained model generation device 10. The controller 11 causes individual functional units, which will be described later, to function appropriately and executes a trained model generation program 15 stored in advance in the storage 14. The controller 11 includes functional units such as an acquisition unit 12 and a training unit 13.

The acquisition unit 12 of the controller 11 acquires training data entered into the trained model generation device 10 and stores the acquired training data into a database 16 built in the storage 14. The training data may be entered directly into the trained model generation device 10 by a user of the trained model generation device 10 or may be acquired from another device via a network.

The acquisition unit 12 may acquire the training data by any method. The training data corresponds to information for generating a trained model that achieves a training objective. The training objective herein is to yield evaluation of an article including a coating material fixed on a substrate or to yield optimal coating material information for acquiring target article evaluation. This will be specifically described later.

The training unit 13 extracts a learning data set from the training data stored in the storage 14 and automatically performs machine learning. The learning data set is a set of data, whose correct answer to an input is known. The learning data set extracted from the training data varies according to the training objective. This training performed by the training unit 13 leads to generation of the trained model.

### (2-2) Machine Learning

An approach of the training unit 13 to perform machine learning may be any supervised learning using a learning data set. Examples of a model or algorithm used for the supervised learning include regression analysis, a decision tree, a support vector machine, a neural network, ensemble learning, and a random forest. Classification may be performed in advance and the individual classes may then be subjected to supervised learning. This classification may be supervised or may be unsupervised.

Examples of the regression analysis include linear regression analysis, multiple regression analysis, and logistic regression analysis. The regression analysis is an approach to fit a model between input data (explanatory variable) and learning data (object variable) by the least-squares method. The explanatory variable is one-dimensional for linear regression analysis and is two-dimensional for multiple regression analysis. The logistic regression analysis uses a logistic function (sigmoid function) as a model. In the case of a high-dimensional explanatory variable, preferably, dimensionality reduction is performed before regression analysis as in the case of principal component regression analysis or partial least squares regression analysis.

The decision tree is a model that includes a combination of classifiers to generate a complex classification boundary. The decision tree will be specifically described later.

The support vector machine is an algorithm that generates a two-class linear discriminant function. The support vector machine will be specifically described later.

The neural network is modeled after a network formed by connecting neurons of the human central nervous system via synapses. The neural network, in a narrow sense, means a multilayer perceptron using backpropagation. Typical examples of the neural network include a convolutional neural network (CNN) and a recurrent neural network (RNN). The CNN is one of feedforward propagation neural networks which are not fully connected (which are sparsely connected). The neural network will be specifically described later.

The ensemble learning is an approach to improve the discriminative performance with a combination of models. Examples of approaches used in the ensemble learning include bagging, boosting, and a random forest. The bagging is an approach to train a plurality of models using bootstrap samples of learning data and to thereby determine the evaluation of novel input data by a majority decision of the models. The boosting is an approach to weigh learning data in accordance with training results of bagging and to thereby cause the model to learn the incorrectly classified learning data more intensively than the correctly classified learning data. The random forest is an approach, in the case of using a decision tree as a model, to generate a set of decision trees (random forest) composed of a plurality of weakly correlated decision trees. The random forest will be specifically described later.

The approach of the machine learning is preferably ensemble learning, more preferably ensemble learning using an XGboost and a support vector machine.

### (2-2-1) Decision Tree

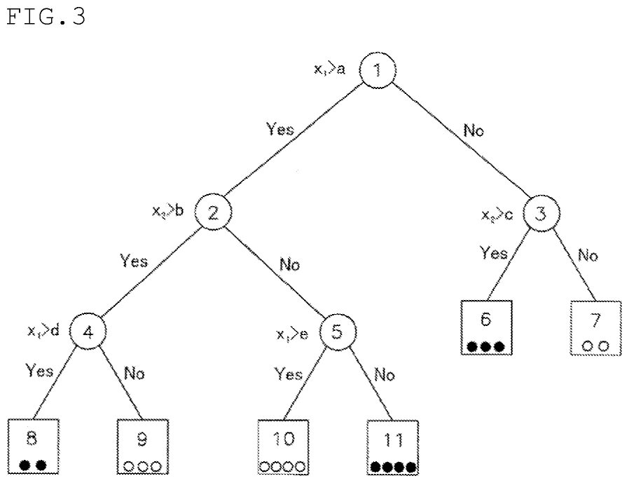

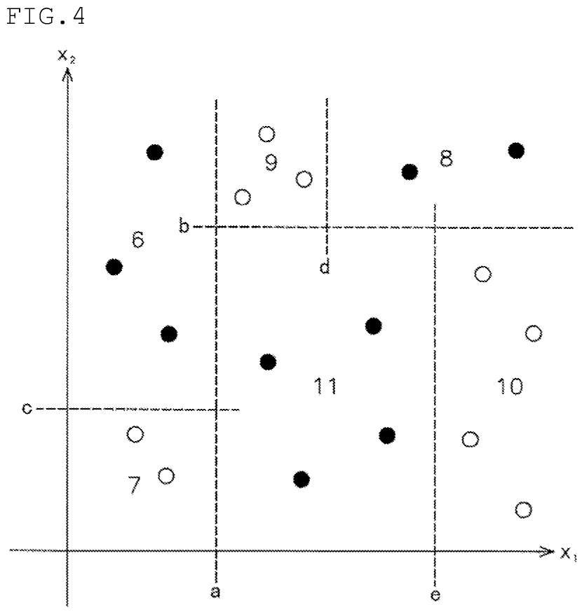

The decision tree is a model that includes a combination of classifiers to generate a complex classification boundary (e.g., a non-linear discriminant function). The classifiers each may be, for example, a rule relating to the relationship of magnitudes between the value of a feature axis and a threshold. A method for building a decision tree from learning data may be a divide and conquer technique of repeatedly determining the rule (classifier) of bisecting a feature space. FIG. 3 is an example of a decision tree built by the divide and conquer technique. FIG. 4 is an example of a feature space split by the decision tree of FIG. 3. In FIG. 4, learning data items are indicated by white or black dots and each classified into a white dot class or a black dot class by the decision tree in FIG. 3. FIG. 3 indicates nodes numbered from 1 to 11 and links each connecting the corresponding nodes and labeled with YES or NO. In FIG. 3, terminal nodes (leaf nodes) are indicated by squares, while non-terminal nodes (the root node and internal nodes) are indicated by circles. The terminal nodes are nodes numbered with 6 to 11, while the non-terminal nodes are nodes numbered with 1 to 5. Each terminal node includes white dots or black dots that represent learning data items. Each non-terminal node is provided with a classifier. The classifiers are each a rule for determining the relationship of magnitudes between the value of a feature axis X₁ or X₂ and one of thresholds a to e. The label of each link indicates the result determined by the classifier. In FIG. 4, the classifiers are indicated by dotted lines and the regions defined by the classifiers are provided with the respective node numbers.

The process of constructing an appropriate decision tree by the divide and conquer technique includes the following three examinations (a) to (c):
(a) selecting a feature axis and a threshold for constructing a classifier;
(b) determining terminal nodes, e.g., the number of classes to which learning data of one terminal node belong, or selecting the range of pruning the decision tree (forming subtrees derived from the same root node); and
(c) assigning the classes to the terminal nodes by majority decision.

Examples of training methods for the decision tree include CART, ID3, and C4.5. CART is an approach to generate a binary tree as a decision tree by bisecting a feature space for each feature axis at each node other than the terminal nodes, as shown in FIG. 3 and FIG. 4.

In training with a decision tree, dividing the feature space at an optimal candidate point of division in a non-terminal node is important to improve the classification performance of the learning data. An evaluation function referred to as impurity may be used as a parameter for evaluating a candidate point of division for a feature space. A function I(t) that represents the impurity of a node t may be any of the parameters represented by the following formulas (1-1) to (1-3), wherein K represents the number of classes.
(a) Error rate at node t

$$\begin{matrix}[ Math . 1 ] & \\ I ( t ) = 1 - {max}_{i} P ( {C}_{i} \vert t ) & ( 1 - 1 )\end{matrix}$$

(b) Cross-entropy (deviance)

$$\begin{matrix}[ Math . 2 ] & \\ I ( t ) = - {\sum }_{i = 1}^{K} P ( {C}_{i} \vert t ) ln P ( {C}_{i} \vert t ) & ( 1 - 2 )\end{matrix}$$

(c) Gini coefficient

$$\begin{matrix}[ Math . 3 ] & \\ I ( t ) = {\sum }_{i - 1}^{K} {\sum }_{j \neq i} P ( {C}_{i} \vert t ) P ( {C}_{j} \vert t ) = {\sum }_{i - 1}^{K} P ( {C}_{i} \vert t ) ( 1 - P ( {C}_{i} \vert t ) ) & ( 1 - 3 )\end{matrix}$$

In the above formulas, the probability P(Cᵢ|t) refers to the posterior probability of a class Cᵢ at the node t, i.e., the probability that data of the class Cᵢ are selected at the node t. In the second expression of the formula (1-3), the probability P(Cⱼ|t) refers to the probability that the data of the class Cᵢ is confused with the j-th (not i-th) class; In other words, the second expression refers to the error rate at the node t. The third expression of the formula (1-3) refers to the sum of variance of the probability P(Cⱼ|t) relating to all classes.

In the case of dividing a node using the impurity as an evaluation function, for example, an approach used is pruning a decision tree to fall within an allowable range defined by the error rate at the node and the complexity of the decision tree.

### (2-2-2) Support Vector Machine

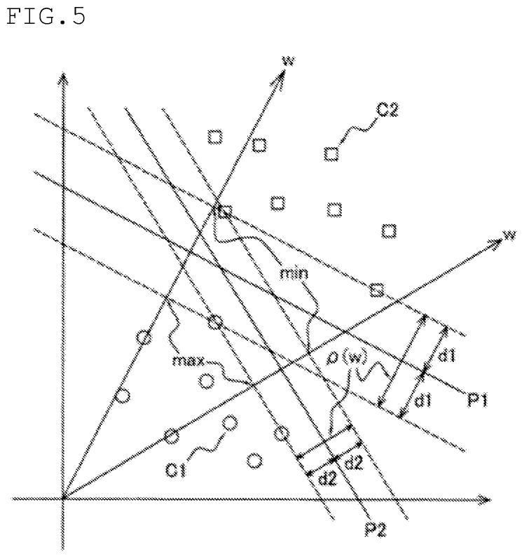

The support vector machine (SVM) is an algorithm of determining a two-class linear discriminant function that achieves the maximum margin. FIG. 5 is a diagram for illustrating a SVM. The two-class linear discriminant function refers to, in the feature space shown in FIG. 5, classification hyperplanes P1 and P2, which are hyperplanes for linear separation of the learning data of two classes C1 and C2. In FIG. 5, the learning data items of the class C1 are indicated by circles, while the learning data items of the class C2 are indicated by squares. The margin of a classification hyperplane refers to the distance between the classification hyperplane and the learning data item closest to the classification hyperplane. FIG. 5 shows a margin d1 of the classification hyperplane P1 and a margin d2 of the classification hyperplane P2. The SVM determines an optimal classification hyperplane P1, which is a classification hyperplane having the maximum margin. The minimum value d1 of the distance between the learning data of the class C1 and the optimal classification hyperplane P1 is equal to the minimum value d2 of the distance between the learning data of the class C2 and an optimal classification hyperplane P2.

A learning data set D_{L} used for the supervised learning of a two-class problem in FIG. 5 is represented by the following formula (2-1).

$$\begin{matrix}[ Math . 4 ] & \\ {D}_{L} = \{ ( {t}_{i} , {x}_{i} ) \} ( i = 1 , … , N ) & ( 2 - 1 )\end{matrix}$$

The learning data set D_{L} is a set of pairs of a learning data item (feature vector) xᵢ and a training data item tᵢ={−1, +1}. The number of elements in the learning data set D_{L} is represented by N. The training data item ti indicates which one of the classes C1 and C2 the learning data item xᵢ belongs to. The class C1 is a class of tᵢ=−1, while the class C2 is a class of tᵢ=+1.

In FIG. 5, a normalized linear discriminant function which holds for every learning data item xᵢ is represented by the following two inequalities (2-2) and (2-3). In the formulas, w represents the coefficient vector and b represents the bias.

$$\begin{matrix}[ Math . 5 ] & \\ at {t}_{i} = + 1 , {w}^{T} {x}_{i} + b \geq + 1 & ( 2 - 2 )\end{matrix}$$

$$at {t}_{i} = - 1 , {w}^{T} {x}_{i} + b \leq - 1 \qquad ( 2 - 3 )$$

These two inequalities are collectively represented by the following single inequality (2-4).

$$\begin{matrix}[ Math . 6 ] & \\ {t}_{i} ( {w}^{T} {x}_{i} + b ) \geq 1 & ( 2 - 4 )\end{matrix}$$

In the case where the classification hyperplanes P1 and P2 are represented by the following formula (2-5), the margin d thereof is represented by the following formula (2-6).

$$\begin{matrix}[ Math . 7 ] & \\ {w}^{T} x + b = 0 & ( 2 - 5 )\end{matrix}$$

$$d = \frac{1}{2} ρ ( w ) = \frac{1}{2} ( {min}_{{x}_{i} ∈ {C}_{2}} \frac{{w}^{T} {x}_{i}}{‖ w ‖} - {max}_{{x}_{i} ∈ {C}_{1}} \frac{{w}^{T} {x}_{i}}{‖ w ‖} ) \qquad ( 2 - 6 )$$

In the formula (2-6), p (w) represents the minimum difference between the lengths of learning data items xᵢ of the classes C1 and C2 projected on a normal vector w of each of the classification hyperplanes P1 and P2. The items “min” and “max” in the formula (2-6) represent the respective points denoted by the symbols “min” and “max” in FIG. 5. In FIG. 5, the optimal classification hyperplane is the classification hyperplane P1 of which the margin d is the maximum.

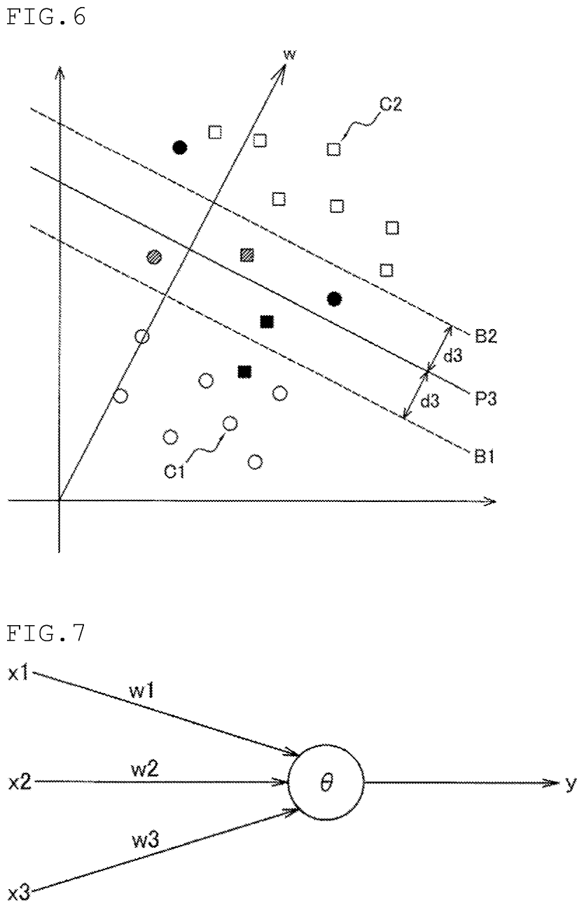

FIG. 5 shows a feature space in which the two-class learning data is linearly separable. FIG. 6 shows a feature space similar to that of FIG. 5, in which two-class learning data is linearly inseparable. In the case where the two-class learning data is linearly inseparable, the following inequality (2-7) may be used, which is extended from the inequality (2-4) by introducing a slack variable ξᵢ.

$$\begin{matrix}[ Math . 8 ] & \\ {t}_{i} ( {w}^{T} {x}_{i} + b ) - 1 + {ξ}_{i} \geq 0 & ( 2 - 7 )\end{matrix}$$

The slack variable Si is used only for training and has a value of 0 or greater. FIG. 6 shows a classification hyperplane P3, margin boundaries B1 and B2, and a margin d3. The formula of the classification hyperplane P3 is the same as the formula (2-5). The margin boundaries B1 and B2 are hyperplanes spaced from the classification hyperplane P3 by the margin d3.

In the case where the slack variable ξᵢ is 0, the formula (2-7) is equivalent to the formula (2-4). In this case, the learning data items xᵢ satisfying the formula (2-7) are correctly classified within the margin d3, as indicated by white circles or white squares in FIG. 6. In this case, the distance between the individual learning data item xᵢ and the classification hyperplane P3 is not smaller than the margin d3.

In the case where the slack variable ξᵢ is greater than 0 but not greater than 1, the learning data items xᵢ satisfying the formula (2-7) are beyond the margin boundary B1 or B2 but not beyond the classification hyperplane P3 and are therefore classified correctly, as indicated by a hatched circle or a hatched square in FIG. 6. In this case, the distance between the individual learning data item xᵢ and the classification hyperplane P3 is smaller than the margin d3.

In the case where the slack variable ξᵢ is greater than 1, the learning data items xᵢ satisfying the formula (2-7) are beyond the classification hyperplane P3 and are therefore classified incorrectly, as indicated by black circles or black squares in FIG. 6.

As described above, the formula (2-7) with the slack variable ξᵢ introduced therein enables classification of the learning data items xᵢ in the case where the two-class learning data is linearly inseparable.

According to the aforementioned description, the sum of the slack variables ξᵢ of all learning data items xᵢ represents the upper limit of the number of learning data items xᵢ classified incorrectly. An evaluation function Lₚ is defined by the following formula (2-8).

$$\begin{matrix}[ Math . 9 ] & \\ {L}_{p} ( w , ξ ) = \frac{1}{2} {w}^{T} w + C {\sum }_{i = 1}^{N} {ξ}_{i} & ( 2 - 8 )\end{matrix}$$

A solution (w, ξ) that minimizes the output of the evaluation function Lₚ is determined. In the equation (2-8), the parameter C in the second term represents the strength of penalty for incorrect classification. The greater the parameter C, the more the resulting solution precedes reduction in the number of incorrect classifications (second term) than reduction in the norm of w (first term).

### (2-2-3) Neural Network

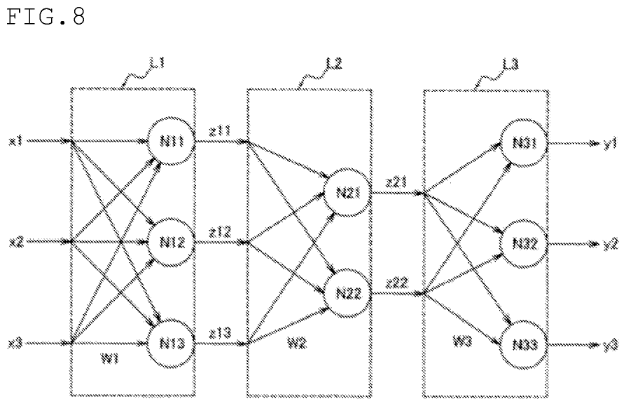

FIG. 7 is a schematic diagram of a model of a neuron in a neural network. FIG. 8 is a schematic diagram of a three-layer neural network constructed by combining the neurons shown in FIG. 7. As shown in FIG. 7, the neuron yields an output y for a plurality of inputs x (inputs x1, x2, and x3 in FIG. 7). Each of the inputs x (inputs x1, x2, and x3 in FIG. 7) is multiplied by a corresponding weight w (weights w1, w2, and w3 in FIG. 7). The neuron yields the output y using the following formula (3-1).

$$\begin{matrix}[ Math . 10 ] & \\ y = φ ( {\sum }_{i = 1}^{N} {x}_{i} {w}_{i} - θ ) & ( 3 - 1 )\end{matrix}$$

In the formula (3-1), the input x, the output y, and the weight w are all vectors; θ is a bias; and φ is an activation function. The activation function is a non-linear function such as a step function (formal neuron), a simple perceptron, a sigmoid function, or a ReLU (ramp function).

The three-layer neural network shown in FIG. 8 receives input vectors x (input vectors x1, x2, and x3 in FIG. 8) from the input side (left side of FIG. 8) and yields output vectors y (output vectors y1, y2, and y3 in FIG. 8) from the output side (right side of FIG. 8). This neural network is composed of three layers L1, L2, and L3.

In the first layer L1, the input vectors x1, x2, and x3 are multiplied by respective weights and then entered into each of three neurons N11, N12, and N13. In FIG. 8, these weights are collectively represented by W1. The neurons N11, N12, and N13 respectively yield feature vectors z11, z12, and z13.

In the second layer L2, the feature vectors z11, z12, and z13 are multiplied by respective weights and then entered into each of two neurons N21 and N22. In FIG. 8, these weights are collectively represented by W2. The neurons N21 and N22 respectively yield feature vectors z21 and z22.

In the third layer L3, the feature vectors z21 and z22 are multiplied by respective weights and then entered into each of three neurons N31, N32, and N33. In FIG. 8, these weights are collectively represented by W3. The neurons N31, N32, and N33 respectively yield output vectors y1, y2, and y3.

The neural network functions in a training mode and a prediction mode. The neural network in the training mode learns the weights W1, W2, and W3 using a learning data set. The neural network in the prediction mode executes prediction, such as classification, using the parameters of the weights W1, W2, and W3 learned.

The neural network can learn the weights W1, W2, and W3 by the backpropagation, for example. In this case, information relating to the error is propagated from the output side to the input side, in other words, from the right side to the left side in FIG. 8. The backpropagation is an approach to cause each neuron to learn the weights W1, W2, and W3 adjusted so as to reduce the difference between an output y in response to an input x and the true output y (training data). Examples of an approach to optimize the weights include common approaches such as stochastic gradient descent, RMSprop, and Adamax.

The neural network may include more than three layers. An approach to perform machine learning with a neural network including four or more layers is known as deep learning.

### (2-2-4) Random Forest

The random forest is a type of ensemble learning and is an approach to reinforce the classification performance by combining decision trees. Learning with random forest generates a set (random forest) of weakly correlated decision trees. The random forest is generated and classified by the following algorithm.
(A) Repeat the following steps from m=1 to m=M.
   (a) From N d-dimensional learning data items, generate m bootstrap samples Zₘ.
   (b) Using Zₘ as learning data, divide each node t in the following procedure to generate m decision trees.
      (i) From d features, randomly select d′ features (d′<d).
      (ii) From among the d′ features selected, determine a feature and a division point (threshold) that yield the optimal division of the learning data.
      (iii) Divide the node t into two at the division point determined.
(B) Yield a random forest composed of the m decision trees.

(C) In response to input data, acquire classification results of the respective decision trees in the random forest. The classification result of the random forest is determined by majority vote of the classification results of the respective decision trees.

The learning with random forest can weaken the correlation between decision trees through random selection of a preset number of features used for classification at each non-terminal node of the decision trees.

### (2-3) Storage 14

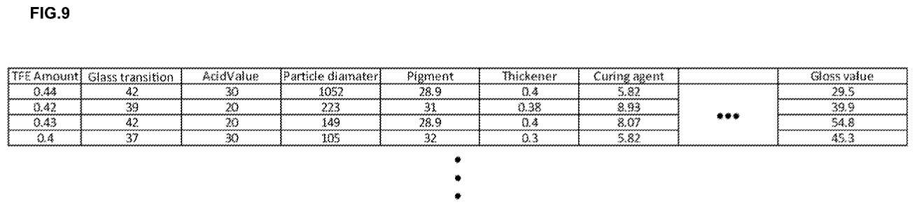

The storage 14 shown in FIG. 1 is an example of a storage medium and includes, for example, a flash memory, a RAM, or a HDD. The storage 14 stores in advance the trained model generation program 15 to be executed by the controller 11. The storage 14 includes the database 16 built therein, in which a plurality of the training data acquired by the acquisition unit 12 are stored and appropriately managed. The database 16 stores a plurality of training data as shown in FIG. 9, for example. FIG. 9 shows some of the training data stored in the database 16. In addition to the training data, the storage 14 may also store information for generating a trained model, such as a learning data set and test data.

### (3) Training Data

Correlation is found between coating material information and evaluation of an article. Thus, the training data to be acquired for generating a trained model based on this correlation includes at least the coating material information and information relating to evaluation of an article to be described below. To increase the accuracy of an output, the training data also preferably include substrate information.

As a matter of course, the training data may also include information other than the following types of information. The database 16 in the storage 14 according to the disclosure stores a plurality of the training data including the following types of information.

### (3-1) Coating Material Information

The coating material information corresponds to information relating to the coating material to be fixed on a substrate. The coating material of the disclosure may be one to form a coating film having a thickness of 10 μm or greater on a substrate.

The coating material information may include information relating to a polymer contained in the coating material.

The polymer preferably includes a fluorine-containing polymer.

The fluorine-containing polymer preferably includes a unit based on a fluorine-containing monomer. Examples of the fluorine-containing monomer include tetrafluoroethylene, chlorotrifluoroethylene, vinylidene fluoride, vinyl fluoride, trans-1,3,3,3-tetrafluoropropene (HFO-1234ze), 2,3,3,3-tetrafluoropropene (HFO-1234yf), and fluorovinyl ether. One or two or more of these may be used.

Preferred among these is at least one selected from the group consisting of tetrafluoroethylene (TFE), chlorotrifluoroethylene, and vinylidene fluoride.

The polymer may be a curable functional group-containing polymer or may be a curable functional group-containing fluorine-containing polymer. Examples of the curable functional group include a hydroxy group, a carboxyl group, a group represented by —COOCO—, an amino group, a glycidyl group, a silyl group, a silanate group, and an isocyanate group. Preferred is a hydroxy group. The curable functional group may be introduced into a fluoropolymer by, for example, copolymerization with a curable functional group-containing monomer.

The information relating to a polymer may include monomer information corresponding to information of a monomer defining the polymer. Examples of the monomer information include the type and amount of the monomer (amount of a unit based on the monomer).

Examples of the monomer include the aforementioned fluorine-containing monomers, a hydroxy group-containing monomer, a vinyl ester containing neither a hydroxy group nor an aromatic ring, a carboxylic acid vinyl ester containing an aromatic ring and containing no hydroxy group, a carboxyl group-containing monomer, an amino group-containing monomer, a hydrolyzable silyl group-containing monomer, an alkyl vinyl ether containing no hydroxy group, and an olefin containing neither a halogen atom nor a hydroxy group.

The amounts of the monomer units defining the polymer may be calculated by appropriate combination of NMR, FT-IR, elemental analysis, and X-ray fluorescence analysis in accordance with the types of the monomers.

The information relating to a polymer may also include physical properties information corresponding to information of physical properties of the polymer, such as a glass transition temperature (Tg), acid value, hydroxyl value, and molecular weight of the polymer.

The Tg can be determined using a differential scanning calorimeter (DSC) (second run), for example.

The acid value can be determined by the neutralization titration in conformity with JIS K5601, for example.

The hydroxyl value can be calculated from the mass of the polymer and the amount of substance of the hydroxy group. The amount of substance of the —OH group can be determined by, for example, NMR measurement, IR measurement, titration, or elemental analysis. The hydroxyl value can also be calculated from the actual amount of the hydroxy group monomer during polymerization and the solid concentration.

The molecular weight can be determined by gel permeation chromatography (GPC), for example.

The information relating to a polymer may also include particle size information corresponding to information of the particle size of the polymer.

The particle size may be the average particle size of polymer particles contained in the coating material, and can be determined by dynamic light scattering, for example.

The information relating to a polymer may also include polymer amount information corresponding to information of the amount of the polymer in the coating material.

The coating material information may also include information relating to a component other than the polymer contained in the coating material.

An example of the component other than the polymer include a liquid medium. The coating material may be one in which the polymer is dissolved or dispersed in a liquid medium.

Examples of the liquid medium include water, an organic solvent, and a solvent mixture of water and an organic solvent.

The liquid medium may be an aqueous medium containing water, and the coating material may be an aqueous coating material in which particles of the polymer are dispersed in the aqueous medium.

The information relating to a component other than the polymer may include medium information corresponding to information of the liquid medium, which may include information relating to the type and amount of the liquid medium.

Examples of the component other than the polymer include additives such as a surfactant, a dispersant, a viscosity modifier, a film-forming aid, a film-forming agent, an antifoam, a drying retarder, a thixotropic agent, a pH adjuster, a pigment, a conductive agent, an antistatic agent, a leveling agent, an anticissing, a flatting agent, an anti-blocking agent, a thermal stabilizer, an antioxidant, an anti-wear agent, a filler, an anti-corrosive agent, a curing agent, an acid acceptor, a ultraviolet absorber, a photostabilizer, an antifungal agent, an antibacterial agent, and a neutralizer.

The information relating to a component other than the polymer may include additive information corresponding to information of the additive, which may include information relating to the type and amount of the additive.

The information relating to a component other than the polymer may include curing agent information corresponding to information of the curing agent.

The curing agent is preferably an isocyanate curing agent such as a polyisocyanate compound.

The curing agent information may include information relating to the type and amount of the curing agent, and preferably includes information relating to the amount of the curing agent.

The information relating to a component other than the polymer may include pigment information corresponding to information of the pigment.

The pigment information may include information relating to the type and amount of the pigment.

The coating material in the disclosure preferably contains a pigment.

The information relating to a component other than the polymer may also include viscosity modifier information corresponding to information of the viscosity modifier.

An example of the viscosity modifier may be a thickening agent.

The viscosity modifier information may include information relating to the type and amount of the viscosity modifier, and preferably includes information relating to the amount of the viscosity modifier.

The information relating to a component other than the polymer may also include neutralizer information corresponding to information of the neutralizer.

Examples of the neutralizer include ammonia, an organic amine, and an alkali metal hydroxide.

The neutralizer information may include information relating to the type, acid dissociation constant, and amount of the neutralizer, and preferably includes information relating to the acid dissociation constant and amount of the neutralizer.

The information relating to a component other than the polymer includes:
preferably at least one set of information selected from the group consisting of the medium information and the additive information;
more preferably at least one set of information selected from the group consisting of the medium information, the curing agent information, the pigment information, the viscosity modifier information, and the neutralizer information;
still more preferably at least one set of information selected from the group consisting of the curing agent information, the pigment information, the viscosity modifier information, and the neutralizer information.

The coating material information includes:
preferably at least one set of information selected from the group consisting of the information relating to a polymer and the information relating to a component other than the polymer;
more preferably at least one set of information selected from the group consisting of the monomer information, the polymer amount information, the physical properties information, the particle size information, the curing agent information, the pigment information, the viscosity modifier information, and the neutralizer information;
still more preferably at least one set of information selected from the group consisting of the monomer information, the polymer amount information, the particle size information, the curing agent information, the pigment information, the viscosity modifier information, and the neutralizer information;
further preferably at least one set of information selected from the group consisting of the monomer information, the polymer amount information, and the particle size information and at least one set of information selected from the group consisting of the curing agent information, the pigment information, the viscosity modifier information, and the neutralizer information.

These sets of information particularly strongly correlate with the evaluation of an article and therefore use of these sets of information can yield a more accurate output.

As a matter of course, the coating material information may include information other than the foregoing. The training data shown in FIG. 9 includes each of the aforementioned items encompassed by the coating material information, but part of which is not shown in the figure.

### (3-2) Substrate Information

The substrate information corresponds to information of a substrate that is a target of fixing the coating material.

Examples of the substrate information include information relating to the material, surface status, thickness, and the like of the substrate.

Examples of the material include metals such as aluminum, stainless steel, and iron, plastics such as heat-resistant resin and heat-resistant rubber, ceramics, and fine ceramics. Examples of the metals include a simple metal and alloy.

The material preferably includes at least one selected from the group consisting of a metal, a plastic, and a ceramic.

The substrate is preferably not a textile product.

An example of the surface status is a surface roughness of the substrate. An example of the surface roughness is a surface roughness parameter determined in conformity with JIS B0601-2001.

Another example of the surface status is the presence or absence of surface treatment on the substrate. Examples of the surface treatment include degreasing treatment and surface roughening treatment. Examples of methods for the degreasing treatment include a method of cleaning the surface with a solvent or a method of baking the surface to thermolytically remove impurities such as oil. Examples of methods for the surface roughening treatment include chemical etching with acid or alkali, anodic oxidation (anodizing), and sand blasting.

The substrate information includes:
preferably information relating to at least one selected from the group consisting of the material, surface status, and thickness of the substrate;
more preferably information relating to at least one selected from the group consisting of the material, surface roughness, and thickness of the substrate;
still more preferably information relating to at least one selected from the group consisting of the material and surface roughness of the substrate;
further preferably information relating to the surface roughness of the substrate;
particularly preferably information relating to the material and surface roughness of the substrate.

These sets of information particularly strongly correlate with the evaluation of an article and therefore use of these sets of information can yield a more accurate output.

As a matter of course, the substrate information may include information other than the foregoing. The training data shown in FIG. 9 includes each of the aforementioned items encompassed by the substrate information, but part of which is not shown in the figure.

### (3-3) Evaluation

The evaluation corresponds to information of an article including the coating material fixed on the substrate. The article may be one including a coating film of the coating material formed on the substrate. The coating film preferably has a thickness of 10 μm or greater. The coating film may have a multilayer structure.

The evaluation preferably includes information of any property of the article, and may include information such as accelerated weathering resistance, a gloss value, a color difference, adhesiveness, impact resistance, solvent resistance, acid resistance, alkali resistance, a contact angle, a surface free energy, solvent resistance, gas permeability, dirt resistance, recoatability, water vapor permeability, and water absorbency.

Each of the items may be determined or evaluated by any method that can express the property of each item by a numerical value, for example. Any known test device or test method may be used. Measurement or evaluation may be performed in conformity with any standard such as JIS, ASTM, or ISO.

The accelerated weathering resistance may be determined using, for example, a sunshine carbon arc weatherometer (SWOM), a ultra-accelerated metal halide weatherometer, a sunshine weatherometer, a UV auto fade meter, a xenon weatherometer, an ozone weatherometer, or a salt spray test device.

The gloss value may be determined in conformity with JIS K5600, for example.

The color difference may be numerical expression of the result of visual observation, or may be determined using a spectrocolorimeter or a color difference meter.

The adhesiveness may be determined by a cross hatch test, a cross cut test, or a peeling test, for example.

The impact resistance may be determined in conformity with JIS K5600-5-3, for example.

The solvent resistance may be determined in conformity with JIS K5600-6-1, for example.

The acid resistance may be determined in conformity with JIS K5600-6-1, for example.

The alkali resistance may be determined in conformity with JIS K5600-6-1, for example.

The contact angle may be determined using a contact angle meter, for example.

The surface free energy may be determined by measuring the contact angles between a target article and two or more liquid reagents each having known physical properties and then calculating the surface free energy from the measured contact angles.

The gas permeability may be determined by a pressure sensor method or gas chromatography, for example.

The dirt resistance may be determined by a carbon contamination test, for example.

The recoatability may be determined by forming multiple layers of the same type of coating material and observing the adhesiveness.

The water vapor permeability may be determined by a method for determination of water vapor transmission rate of moisture (dish method), for example.

The water absorbency may be expressed by the coefficient of water absorption, and may be determined in conformity with JIS K7209, for example.

The items of the evaluation may be selected in accordance with the intended use of the article. Examples of the use include use for corrosion resistance of building materials, vehicles, ships, inner surfaces of pipes, inner surfaces of tanks, inner surfaces of containers, inner surfaces of tank trucks, inner surfaces of pumps, inner surfaces of valves, stirring blades, towers, centrifuges, heat exchangers, plating jigs, and screw conveyers; semiconductor-related use for inner surfaces of exhaust ducts in semiconductor factories; industrial mold release use for rolls for OA equipment, belts for OA equipment, separation claws for OA equipment, paper-making rolls, calender rolls for film making, and injection molds; use related to household appliances or kitchen such as rice cookers, electric kettles, electric griddles, frying pans, bread makers, bread trays, inner walls of microwave ovens, top plates of gas cooktops, top plates for bread, pans, pots, kitchen knives, ice trays, and irons; sliding parts such as metal foil, electric wires, food processing machinery, packaging machinery, spinning machinery, pistons for automobile air conditioner compressors, and a variety of gears; and use related to industrial parts such as mill rolls, conveyors, hoppers, packings, valve seals, oil seals, joints, antenna covers, connectors, gaskets, embedded bolts, and embedded nuts.

The use is preferably building materials, vehicles, and ships, more preferably building materials.

The use is also preferably other than the exterior of vehicles and ships.

The evaluation preferably includes information relating to at least one selected from the group consisting of accelerated weathering resistance, a gloss value, color difference, adhesiveness, impact resistance, solvent resistance, acid resistance, alkali resistance, a contact angle, a surface free energy, solvent resistance, gas permeability, dirt resistance, recoatability, water vapor permeability, and water absorbency, more preferably includes information relating to at least one selected from the group consisting of accelerated weathering resistance, a gloss value, color difference, a contact angle, a surface free energy, water vapor permeability, and water absorbency, particularly preferably includes information relating to accelerated weathering resistance.

As a matter of course, the evaluation may include information other than the foregoing. The training data shown in FIG. 9 includes each of the aforementioned items encompassed by the evaluation, but part of which is not shown in the figure.

### (4) Operations of Trained Model Generation Device 10

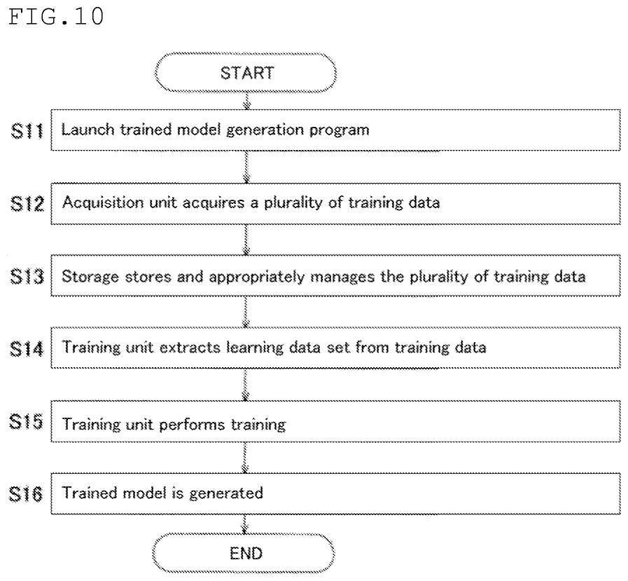

With reference to FIG. 10, an outline of the operations of the trained model generation device 10 is described below.

First, in Step S11, the trained model generation device 10 launches the trained model generation program 15 stored in the storage 14. The trained model generation device 10 thereby operates based on the trained model generation program 15 to start generating a trained model.

In Step S12, the acquisition unit 12 acquires a plurality of training data based on the trained model generation program 15.

In Step S13, the acquisition unit 12 stores the plurality of training data into the database 16 built in the storage 14. The storage 14 stores and appropriately manages the plurality of training data.

In Step S14, the training unit 13 extracts a learning data set from the training data stored in the storage 14. A data set to be extracted is determined according to a training objective of the trained model to be generated by the trained model generation device 10. The data set is based on the training data.

In Step S15, the training unit 13 performs training based on a plurality of data sets extracted.

In Step S16, a trained model according to the training objective is generated based on the results of the training by the training unit 13 in Step S15.

The operations of the trained model generation device 10 are thus terminated. The properties such as the order of the operations of the trained model generation device 10 may be changed as appropriate. The generated trained model is implemented to a general-purpose computer or terminal, or downloaded as software or an application, or distributed while being stored in a storage medium, for practical use.

### (5) Structure of User Device 20

FIG. 2 shows a structure of the user device 20 used by a user in the present embodiment. The term “user” as used herein refers to a person who enters some information into the user device 20 or causes the user device 20 to yield some information. The user device 20 uses the trained model generated by the trained model generation device 10.

The user device 20 is a device having functions of a computer. The user device 20 may include a communication interface such as a NIC and a DMA controller and may be communicable with, for example, the trained model generation device 10 via a network. The user device 20 shown in FIG. 2 is illustrated as a single device, but is preferably compatible with cloud computing. Thus, the hardware structure of the user device 20 is not necessarily accommodated in a single housing or provided as a single device. For example, the user device 20 may be structured such that the hardware resources thereof are dynamically connected and disconnected in response to a load.

The user device 20 may include, for example, an input unit 24, an output unit 25, a controller 21, and a storage 26.

### (5-1) Input Unit 24

The input unit 24 may be, for example, a keyboard, a touch screen, or a mouse. The user can enter information into the user device 20 through the input unit 24.

### (5-2) Output Unit 25

The output unit 25 may be, for example, a display or a printer. The output unit 25 can yield a result of analysis by the user device 20 using the trained model as well.

### (5-3) Controller 21

The controller 21 may be a CPU, for example, and executes control of the entire user device 20. The controller 21 includes functional units such as an analysis unit 22 and an update unit 23.

The analysis unit 22 of the controller 21 analyzes the input information entered through the input unit 24 using the trained model as a program stored in the storage 26 in advance. This analysis by the analysis unit 22 is preferably performed according to the aforementioned machine learning approach, although not limited thereto. With the trained model trained in the trained model generation device 10, the analysis unit 22 can yield a correct answer to unknown input information.

The update unit 23 updates the trained model stored in the storage 26 to an optimal status in order to produce a high-quality trained model. The update unit 23 may optimize the weighting between neurons in each layer in a neural network, for example.

### (5-4) Storage 26

The storage 26 is an example of a storage medium and includes, for example, a flash memory, a RAM, or a HDD. The storage 26 stores in advance the trained model to be executed by the controller 21. The storage 26 includes a database 27 in which a plurality of the training data are stored and appropriately managed. The storage 26 may also store other information such as a learning data set. The training data stored in the storage 26 corresponds to information such as the coating material information and the evaluation described above.

### (6) Operations of User Device 20

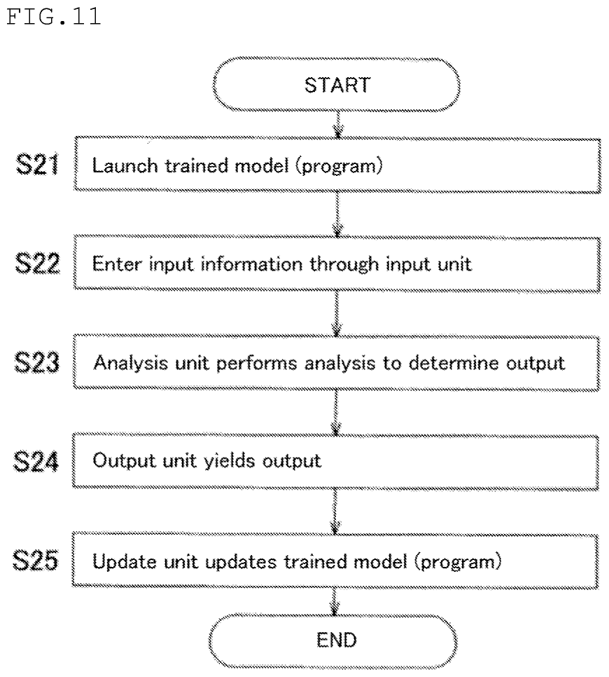

With reference to FIG. 11, an outline of the operations of the user device 20 is described below. The user device 20 is such that the trained model generated by the trained model generation device 10 is stored in the storage 26.

First, in Step S21, the user device 20 launches the trained model stored in the storage 26. The user device 20 operates based on the trained model.

In Step S22, a user of the user device 20 enters input information through the input unit 24. The input information entered through the input unit 24 is transmitted to the controller 21.

In Step S23, the analysis unit 22 of the controller 21 receives and analyzes the input information from the input unit 24 as well as determines information to be yielded from the output unit. The information determined by the analysis unit 22 is transmitted to the output unit 25.

In Step S24, the output unit 25 yields result information yielded from the analysis unit 22.

In Step S25, the update unit 23 updates the trained model to an optimal status based on, for example, the input information and the result information.

The operations of the user device 20 are thus terminated. The properties such as the order of the operations of the user device 20 may be changed as appropriate.

(7) Specific Examples Hereinafter, specific examples are described in which the aforementioned trained model generation device 10 and user device 20 are used.

### (7-1) Model Trained on Accelerated Weathering Resistance

A model trained on accelerated weathering resistance is described here in which the accelerated weathering resistance is yielded as evaluation of an article including a coating material fixed on a substrate.

### (7-1-1) Device 10 for Generating a Model Trained on Accelerated Weathering Resistance

To generate a model trained on accelerated weathering resistance, the device 10 for generating a model trained on accelerated weathering resistance at least acquires a plurality of training data including:
the coating material information including information relating to a polymer contained in the coating material, information relating to a liquid medium contained in the coating material, and information relating to an additive contained in the coating material; and
accelerated weathering resistance information.

The device 10 for generating a model trained on accelerated weathering resistance may acquire another information.

As a result of training based on the training data acquired, the device 10 for generating a model trained on accelerated weathering resistance can generate a model trained on accelerated weathering resistance that receives the coating material information including information relating to a polymer contained in the coating material, information relating to a liquid medium contained in the coating material, and information relating to an additive contained in the coating material and that yields the accelerated weathering resistance information.

### (7-1-2) User Device 20 Using the Model Trained on Accelerated Weathering Resistance

The user device 20 is a device that can utilize the model trained on accelerated weathering resistance. A user of the user device 20 enters the coating material information including information relating to a polymer contained in the coating material, information relating to a liquid medium contained in the coating material, and information relating to an additive contained in the coating material into the user device 20.

The user device 20 uses the model trained on accelerated weathering resistance to determine the accelerated weathering resistance information. The output unit 25 yields the accelerated weathering resistance information determined.

### (7-2) Model Trained on Coating Material

A model trained on coating material is described here in which optimal coating material information for achieving the target accelerated weathering resistance of an article is yielded as an output.

### (7-2-1) Device 10 for Generating a Model Trained on Coating Material

To generate a model trained on coating material, the device 10 for generating a model trained on coating material at least acquires a plurality of training data including:
the coating material information including information relating to a polymer contained in the coating material, information relating to a liquid medium contained in the coating material, and information relating to an additive contained in the coating material; and
accelerated weathering resistance information.

The device 10 for generating a model trained on coating material may acquire another information.

As a result of training based on the training data acquired, the device 10 for generating a model trained on coating material can generate a model trained on coating material that receives the accelerated weathering resistance information and that yields optimal coating material information for acquiring the target accelerated weathering resistance of an article.

### (7-2-2) User Device 20 Using a Model Trained on Coating Material

The user device 20 is a device that can utilize the model trained on coating material. A user of the user device 20 enters the accelerated weathering resistance information into the user device 20.

The user device 20 uses the model trained on coating material to determine optimal coating material information for acquiring the target accelerated weathering resistance of an article. The output unit 25 yields the coating material information determined.

### (8) Characteristics

(8-1)

The trained model generation method of the present embodiment is a trained model generation method for generating a trained model that determines, using a computer, evaluation of an article including a coating material fixed on a substrate. The trained model generation method includes the acquisition step S12, the training step S15, and the generation step S16. The acquisition step S12 includes causing the computer to acquire training data. The training data includes coating material information and the evaluation. The coating material information corresponds to information of the coating material. The training step S15 includes training the computer based on a plurality of the training data acquired in the acquisition step S12. The generation step S16 includes causing the computer to generate a trained model based on training results in the training step S15. The trained model receives input information and yields evaluation. The input information corresponds to unknown information different from the training data. The input information corresponds to information including at least the coating material information.

Further, as described above, the trained model that has been subjected to training using the training data composed of the coating material information and the evaluation is used as a program in the computer, whereby the computer determines evaluation. The trained model includes the input step S22, the determination step S23, and the output step S24. The input step S22 includes entering the input information corresponding to information that includes the coating material information and that corresponds to unknown information different from the training data. The determination step S23 includes determining evaluation using the trained model. The output step S24 includes yielding the evaluation determined in the determination step S23.

In conventional cases, an article including a coating material fixed on a substrate is evaluated by actual evaluation testing on a variety of coating materials. This conventional evaluation method spends extensive time and includes a large number of steps, which arises a demand for an improved evaluation method.

As disclosed in Patent Literature 1, programs using a neural network have been designed so as to yield an optimal combination in the field of surface-treating agents; in contrast, no programs using a neural network have been designed in the field of coating materials.

A trained model generated by the trained model generation method of the present embodiment enables computer-based evaluation. This can reduce extensive time and a large number of steps that have been present in conventional cases. Such reduction in the number of steps can also reduce the number of staffs for evaluation, which can reduce the cost for evaluation.

(8-2)

The trained model generation method of the present embodiment is a method for generating a trained model that determines, using a computer, optimal coating material information for acquiring target article evaluation. This method includes the acquisition step S12, the training step S15, and the generation step S16. The acquisition step S12 includes causing the computer to acquire training data. The training data includes coating material information and evaluation. The coating material information corresponds to information of the coating material. The evaluation corresponds to evaluation of an article including the coating material fixed on the substrate. The training step S15 includes training the computer based on a plurality of the training data acquired in the acquisition step S12. The generation step S16 includes causing the computer to generate a trained model based on training results in the training step S15. The trained model receives input information and yields coating material information. The input information corresponds to unknown information different from the training data. The input information corresponds to information including at least information of evaluation.

Further, as described above, the trained model that has been subjected to training using the training data composed of the coating material information and the evaluation is used as a program in the computer, whereby the computer determines coating material information. The program includes the input step S22, the determination step S23, and the output step S24. The input step S22 includes entering the input information corresponding to information that includes the information of evaluation and that corresponds to unknown information different from the training data. The determination step S23 includes determining optimal coating material information for acquiring target article evaluation using the trained model. The output step S24 includes yielding the coating material information determined in the determination step S23.

In conventional evaluation methods, poor article evaluation leads to additional examination and improvement for finding an optimal coating material, which requires extensive time and a large number of steps.

The trained model generated by the trained model generation method of the present embodiment can cause a computer to determine an optimal coating material for acquiring target article evaluation. This can reduce the time, number of steps, number of staffs, cost, and the like for selecting an optimal coating material.

(8-3)

In the aforementioned trained model generation method and program in the sections (8-1) and (8-2), the training data preferably further includes substrate information corresponding to information of the substrate. In this embodiment, the input information preferably further includes the substrate information.

The training data preferably includes information relating to many items, and the number of training data items is preferably as large as possible. This can lead to a more accurate output.

(8-4)

The training in the training step $15 of the trained model generation method of the present embodiment is preferably performed by regression analysis and/or ensemble learning including a combination of a plurality of regression analyses, more preferably ensemble learning using Xgboost and a support vector machine.

The evaluation of the trained model as the program of the present embodiment preferably includes information relating to at least one selected from the group consisting of accelerated weathering resistance, a gloss value, a color difference, adhesiveness, impact resistance, solvent resistance, acid resistance, alkali resistance, a contact angle, a surface free energy, solvent resistance, gas permeability, dirt resistance, recoatability, water vapor permeability, and water absorbency.

The substrate information includes:
preferably information relating to at least one selected from the group consisting of the material, surface status, and thickness of the substrate;
more preferably information relating to at least one selected from the group consisting of the material, surface roughness, and thickness of the substrate;
still more preferably information relating to at least one selected from the group consisting of the material and surface roughness of the substrate;
further preferably information relating to the surface roughness of the substrate;
particularly preferably information relating to the material and surface roughness of the substrate.

The coating material information includes:
preferably at least one set of information selected from the group consisting of the information relating to a polymer and the information relating to a component other than the polymer;
more preferably at least one set of information selected from the group consisting of the monomer information, the polymer amount information, the physical properties information, the particle size information, the curing agent information, the pigment information, the viscosity modifier information, and the neutralizer information;
still more preferably at least one set of information selected from the group consisting of the monomer information, the polymer amount information, the particle size information, the curing agent information, the pigment information, the viscosity modifier information, and the neutralizer information;
further preferably at least one set of information selected from the group consisting of the monomer information, the polymer amount information, and the particle size information and at least one set of information selected from the group consisting of the curing agent information, the pigment information, the viscosity modifier information, and the neutralizer information.

These sets of information strongly correlate with the evaluation of an article and therefore use of these sets of information can yield a more accurate output.

(8-5)

The trained model as the program of the present embodiment may also be distributed via a storage medium storing the program.

(8-6)

The trained model of the present embodiment is a trained model that has been trained in the trained model generation method.

The trained model of the present embodiment is a trained model causing a computer to function to: perform computation on coating material information corresponding to information of a coating material entered into an input layer of a neural network based on a weight coefficient of the neural network; and yield evaluation of an article including the coating material fixed on a substrate from an output layer of the neural network. The weight coefficient is acquirable by training using training data including at least the coating material information and the evaluation.

(8-7)

The trained model of the present embodiment is a trained model causing a computer to function to: perform computation on information of evaluation of an article including a coating material fixed on a substrate entered into an input layer of a neural network based on a weight coefficient of the neural network; and yield optimal coating material information corresponding to information of the coating material for acquiring target article evaluation from an output layer of the neural network. The weight coefficient is acquirable by training using training data including at least the coating material information and the evaluation.

(8-8)

In the aforementioned trained model in the sections (8-6) and (8-7), the training data preferably further includes substrate information corresponding to information of the substrate. In this embodiment, the input layer preferably further receives the substrate information.

(9)

The embodiments of the disclosure are described hereinabove. It should be understood that various modifications of embodiments and details may be made without departing from the spirit and scope of the disclosure set forth in the Claims.

The disclosure also relates to a trained model generation method for generating a trained model that determines, using a computer, evaluation of an article including a coating material fixed on a substrate, the method including:
an acquisition step (S12) of causing the computer to acquire, as training data, information including at least coating material information and the evaluation of the article, the coating material information corresponding to information of the coating material;
a training step (S15) of training the computer based on a plurality of the training data acquired in the acquisition step (S12); and
a generation step (S16) of causing the computer to generate the trained model based on training results in the training step (S15),
the trained model being configured to receive input information corresponding to unknown information different from the training data and to yield the evaluation,
the input information corresponding to information including at least the coating material information.

The disclosure also relates to a trained model generation method for generating a trained model that determines, using a computer, optimal coating material information for acquiring target article evaluation, the method including:
an acquisition step (S12) of causing the computer to acquire, as training data, information including at least coating material information and evaluation of an article, the coating material information corresponding to information of a coating material to be fixed on a substrate, and the article including the coating material fixed on the substrate;
a training step (S15) of training the computer based on a plurality of the training data acquired in the acquisition step (S12); and
a generation step (S16) of causing the computer to generate the trained model based on training results in the training step (S15),
the trained model being configured to receive input information corresponding to unknown information different from the training data and to yield optimal coating material information for acquiring target article evaluation,
the input information corresponding to information including at least information of the evaluation.

The training in the training step (S15) is preferably performed by regression analysis and/or ensemble learning including a combination of a plurality of regression analyses.

The disclosure also relates to a program causing a computer to determine, using a trained model, evaluation of an article including a coating material fixed on a substrate, the program including:
an input step (S22) of causing the computer to receive input information;
a determination step (S23) of causing the computer to determine the evaluation; and
an output step (S24) of causing the computer to yield the evaluation determined in the determination step (S23),
the trained model being obtainable by training using, as training data, information including at least coating material information and the evaluation, the coating material information corresponding to information of the coating material,
the input information corresponding to information that includes at least the coating material information and that corresponds to unknown information different from the training data.

The disclosure also relates to a program causing a computer to determine, using a trained model, optimal coating material information for acquiring target article evaluation, the program including:
an input step (S22) of causing the computer to receive input information;
a determination step (S23) of causing the computer to determine the optimal coating material information; and
an output step (S24) of causing the computer to yield the optimal coating material information determined in the determination step (S23),
the trained model being obtainable by training using, as training data, information including at least coating material information and evaluation of an article, the coating material information corresponding to information of a coating material, and the article including the coating material fixed on a substrate,
the input information corresponding to information that includes at least information of the evaluation and that corresponds to unknown information different from the training data.

The evaluation preferably includes information relating to at least one selected from the group consisting of accelerated weathering resistance, a gloss value, a color difference, adhesiveness, impact resistance, solvent resistance, acid resistance, alkali resistance, a contact angle, a surface free energy, solvent resistance, gas permeability, dirt resistance, recoatability, water vapor permeability, and water absorbency.

The coating material information preferably includes at least one set of information selected from the group consisting of information relating to a polymer contained in the coating material and information relating to a component that is different from the polymer and that is contained in the coating material.

The coating material information preferably includes at least one set of information selected from the group consisting of:
monomer information corresponding to information of a monomer defining a polymer contained in the coating material;
polymer amount information corresponding to information of an amount of the polymer contained in the coating material;
particle size information corresponding to information of a particle size of the polymer;
curing agent information corresponding to information of a curing agent contained in the coating material;
pigment information corresponding to information of a pigment contained in the coating material;
viscosity modifier information corresponding to information of a viscosity modifier contained in the coating material; and
neutralizer information corresponding to information of a neutralizer contained in the coating material.

The disclosure also relates to a storage medium storing the program.

The disclosure also relates to trained model causing a computer to function to:
perform computation on coating material information entered into an input layer of a neural network based on a weight coefficient of the neural network; and
yield evaluation of an article from an output layer of the neural network,
the weight coefficient being acquirable by training using training data including at least the coating material information and the evaluation,
the coating material information corresponding to information of a coating material to be fixed on a substrate,
the article including the coating material fixed on the substrate,
the evaluation corresponding to evaluation of the article.

The disclosure also relates to a trained model causing a computer to function to:
perform computation on information of evaluation of an article entered into an input layer of a neural network based on a weight coefficient of the neural network; and
yield optimal coating material information for acquiring target article evaluation from an output layer of the neural network,
the weight coefficient being acquirable by training using training data including at least the coating material information and the evaluation,
the coating material information corresponding to information of a coating material to be fixed on a substrate,
the article including the coating material fixed on the substrate,
the evaluation corresponding to evaluation of the article.

### EXAMPLES

The disclosure is described in more detail below with reference to an example, but the disclosure is not limited to this example.

### Example 1

The coating material information was used as input information to estimate and yield the gloss value, after a 1750-hour accelerated weathering resistance test, of an article including a coating material fixed on a substrate.

The input information includes the amount of TFE units, glass transition temperature, acid value, and particle size of a fluorine-containing polymer contained in the coating material as well as the amounts of a pigment, thickening agent, and curing agent. Both the input information and the output information were standardized for training. The training was performed by ensemble learning using Xgboost and a support vector machine. The above input information was used for training.

When the input information shown in Table 1 was entered into a program obtained by the above training, the program successfully yielded the predicted gloss values shown in Table 1. The Coating materials corresponding to the input information shown in Table 1 were actually produced and fixed on respective substrates to provide articles, which were then subjected to a 1750-hour accelerated weathering resistance test. The measured gloss values are shown in Table 1. Comparison between the predicted gloss values and the measured gloss values demonstrates successful prediction with an accuracy as high as 87%.

TABLE 1

| TFE | Glass | | Particle | | | Curing | Predicted | Gloss |
|---|---|---|---|---|---|---|---|---|
| Amount | transition | AcidValue | diamater | Pigment | Thickener | agent | Gloss value | value |
| 0.41 | 48 | 30 | 157 | 23.2 | 0.3 | 7.72 | 28.8 | 27.6 |
| 0.42 | 39 | 20 | 163 | 23.2 | 0.2 | 8.83 | 66.9 | 66.7 |
| 0.43 | 39 | 20 | 158 | 21.9 | 0.2 | 7.44 | 48.7 | 49.3 |
| 0.44 | 34 | 20 | 149 | 21.8 | 0.2 | 10.7 | 44.3 | 44.3 |

### REFERENCE SIGNS LIST

S12: acquisition step
S15: training step
S16: generation step
S22: input step
S23: determination step
S24: output step

1. A trained model generation method for generating a trained model that determines, using a computer, evaluation of an article including a coating material fixed on a substrate, the method comprising:
an acquisition step (S12) of causing the computer to acquire, as training data, information including at least coating material information and the evaluation of the article, the coating material information corresponding to information of the coating material;
a training step (S15) of training the computer based on a plurality of the training data acquired in the acquisition step (S12); and
a generation step (S16) of causing the computer to generate the trained model based on training results in the training step (S15),
the trained model being configured to receive input information corresponding to unknown information different from the training data and to yield the evaluation,
the input information corresponding to information including at least the coating material information.

2. A trained model generation method for generating a trained model that determines, using a computer, optimal coating material information for acquiring target article evaluation, the method comprising:
an acquisition step (S12) of causing the computer to acquire, as training data, information including at least coating material information and evaluation of an article, the coating material information corresponding to information of a coating material to be fixed on a substrate, and the article including the coating material fixed on the substrate;
a training step (S15) of training the computer based on a plurality of the training data acquired in the acquisition step (S12); and
a generation step (S16) of causing the computer to generate the trained model based on training results in the training step (S15),
the trained model being configured to receive input information corresponding to unknown information different from the training data and to yield optimal coating material information for acquiring target article evaluation,
the input information corresponding to information including at least information of the evaluation.

3. The trained model generation method according to claim 1,
wherein the training in the training step (S15) is performed by regression analysis and/or ensemble learning including a combination of a plurality of regression analyses.

4. A program causing a computer to determine, using a trained model, evaluation of an article including a coating material fixed on a substrate, the program comprising:
an input step (S22) of causing the computer to receive input information;
a determination step (S23) of causing the computer to determine the evaluation; and
an output step (S24) of causing the computer to yield the evaluation determined in the determination step (S23),
the trained model being obtainable by training using, as training data, information including at least coating material information and the evaluation, the coating material information corresponding to information of the coating material,
the input information corresponding to information that includes at least the coating material information and that corresponds to unknown information different from the training data.

5. A program causing a computer to determine, using a trained model, optimal coating material information for acquiring target article evaluation, the program comprising:
an input step (S22) of causing the computer to receive input information;
a determination step (S23) of causing the computer to determine the optimal coating material information; and
an output step (S24) of causing the computer to yield the optimal coating material information determined in the determination step (S23),
the trained model being obtainable by training using, as training data, information including at least coating material information and evaluation of an article, the coating material information corresponding to information of a coating material, and the article including the coating material fixed on a substrate,
the input information corresponding to information that includes at least information of the evaluation and that corresponds to unknown information different from the training data.

6. The program according to claim 4,
wherein the evaluation includes information relating to at least one selected from the group consisting of accelerated weathering resistance, a gloss value, a color difference, adhesiveness, impact resistance, solvent resistance, acid resistance, alkali resistance, a contact angle, a surface free energy, solvent resistance, gas permeability, dirt resistance, recoatability, water vapor permeability, and water absorbency.

7. The program according to claim 4,
wherein the coating material information includes at least one set of information selected from the group consisting of information relating to a polymer contained in the coating material and information relating to a component that is different from the polymer and that is contained in the coating material.

8. The program according to claim 4,
wherein the coating material information includes at least one set of information selected from the group consisting of:
monomer information corresponding to information of a monomer defining a polymer contained in the coating material;
polymer amount information corresponding to information of an amount of the polymer contained in the coating material;
particle size information corresponding to information of a particle size of the polymer;
curing agent information corresponding to information of a curing agent contained in the coating material;
pigment information corresponding to information of a pigment contained in the coating material;
viscosity modifier information corresponding to information of a viscosity modifier contained in the coating material; and
neutralizer information corresponding to information of a neutralizer contained in the coating material.

9. A storage medium storing the program according to claim 4.

10. A trained model causing a computer to function to:
perform computation on coating material information entered into an input layer of a neural network based on a weight coefficient of the neural network; and
yield evaluation of an article from an output layer of the neural network,
the weight coefficient being acquirable by training using training data including at least the coating material information and the evaluation,
the coating material information corresponding to information of a coating material to be fixed on a substrate,
the article including the coating material fixed on the substrate,
the evaluation corresponding to evaluation of the article.

11. A trained model causing a computer to function to:
perform computation on information of evaluation of an article entered into an input layer of a neural network based on a weight coefficient of the neural network; and
yield optimal coating material information for acquiring target article evaluation from an output layer of the neural network,
the weight coefficient being acquirable by training using training data including at least the coating material information and the evaluation,
the coating material information corresponding to information of a coating material to be fixed on a substrate,
the article including the coating material fixed on the substrate,
the evaluation corresponding to evaluation of the article.

12. The trained model generation method according to claim 2,
wherein the training in the training step (S15) is performed by regression analysis and/or ensemble learning including a combination of a plurality of regression analyses.

13. The program according to claim 5,
wherein the evaluation includes information relating to at least one selected from the group consisting of accelerated weathering resistance, a gloss value, a color difference, adhesiveness, impact resistance, solvent resistance, acid resistance, alkali resistance, a contact angle, a surface free energy, solvent resistance, gas permeability, dirt resistance, recoatability, water vapor permeability, and water absorbency.

14. The program according to claim 5,
wherein the coating material information includes at least one set of information selected from the group consisting of information relating to a polymer contained in the coating material and information relating to a component that is different from the polymer and that is contained in the coating material.

15. The program according to claim 5,
wherein the coating material information includes at least one set of information selected from the group consisting of:
monomer information corresponding to information of a monomer defining a polymer contained in the coating material;
polymer amount information corresponding to information of an amount of the polymer contained in the coating material;
particle size information corresponding to information of a particle size of the polymer;
curing agent information corresponding to information of a curing agent contained in the coating material;
pigment information corresponding to information of a pigment contained in the coating material;
viscosity modifier information corresponding to information of a viscosity modifier contained in the coating material; and
neutralizer information corresponding to information of a neutralizer contained in the coating material.

16. A storage medium storing the program according to claim 5.
